(19) United States
(12) Patent Application Publication
(10) Pub. No.: US 2011/0119279 A1
(43) Pub. Date: May 19, 2011

(54) EVENT-BASED TRENDING FILTER SYSTEM

(75) Inventors: Paul C. Wacker, Plymouth, MN (US); Kevin B. Moore, Chaska, MN (US)

(73) Assignee: Honeywell International Inc., Morristown, NJ (US)

(21) Appl. No.: 12/617,789

(22) Filed: Nov. 13, 2009

(51) Int. Cl. G06F 17/30

(52) U.S. Cl. 707/754; 707/822; 707/E17.033

(57) ABSTRACT

A system having a pre-analysis filter for monitoring incoming data and selecting out data that contributes to event-based trending. Trending from the selected data may be created, started and stopped on the fly. The selected data may generate a temporary log configuration file to allow the log engine to capture the significant data to be logged into storage. The data in storage may be subject to extensive trend analysis. A result of this system is that the amount of data stored is small compared to the amount of all incoming data.

### BACKGROUND

The invention pertains to data and particularly to collection of the data. More particularly, the invention pertains to efficient data gathering.

### SUMMARY

The invention is a system for collecting data, reducing with an event-based approach limiting the amount of data that is to be logged into storage. There may be automatic dynamic trending of incoming data.

### BRIEF DESCRIPTION OF THE DRAWING

FIG. 1 is a diagram of a system for effective data selection and logging.

### DESCRIPTION

Trending, as generally implemented in heating, ventilation and air conditioning (HVAC) controllers, may be an expensive feature. Several areas may generate expenses. Storage of large trend logs may require much memory plus significant processing power to handle the storage and analyses. Network traffic to gather the required data from remote devices may require high bandwidths. Operator time and expertise may be needed to set up and tune the trends with the appropriate data points and frequencies for different end-user needs. In order to provide maintenance and trouble-shooting data, there may be much data that can be useful from any HVAC zone terminal equipment which lets an expert know if the equipment is operating properly and efficiently. Typically, virtually all of the data may need to be logged continuously so that any events which are being monitored are not missed. Oftentimes, however, trend data are not gathered when not needed if the system has not been set up for continuous logging. Additionally, if adequate trend data are collected, such collection may create large data sets that need to be stored. However, many of these data sets are often never used.

Situation dependent dynamic event-based trending may use intelligent models of the equipment being monitored and interrelated environmental factors, such as weather and thermal characteristics of the building containing the equipment, to create, start, and stop trends on the fly, as required to perform the proper analysis. This may mean that instead of continuous monitoring of the equipment, for example, such as five data points for each zone every five seconds at “24/7” being be logged so as to capture a dynamic signature of inefficient equipment and thus creating, for instance, 400 Kbytes of logs per zone per day. An algorithm could start the log when the proper equipment event provides merely the dynamic information which is needed, and then, after the needed information is received, the algorithm could shut the log off. This approach may allow the network to utilize its bandwidth more efficiently by alternating which zones to monitor so that not too many of them will be generating traffic at once. Also, the present approach may at the same time limit the data logged to less than, for example, 3K bytes per zone per day. The approach may provide automatic dynamic trending on the data.

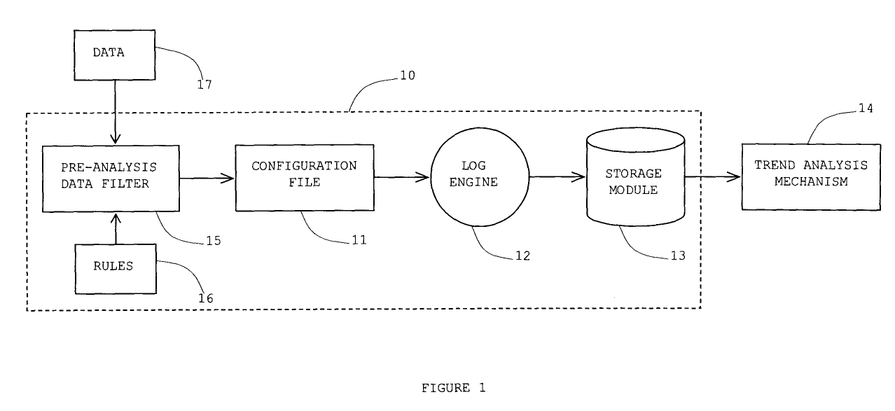

FIG. 1 is a diagram of the present approach and system 10. Collected data 17 may go a pre-analysis data filter 15. An output of filter 15 may go to configuration file 11. The output from configuration file 11 may go to a log engine 12. Filter 15 may make a smart evaluation of the data to determine whether it should be selected and placed into configuration file 11, or discarded. Significant events may be caught with the evaluation at filter 15 and selected data may be provided to configuration file 11. Rules 16 may be provided to filter 15 so as to make an evaluation of the data and determine which data is to be provided to configuration file 11. Data may go from configuration file 11 to log engine 12 which may log the data into a storage device 13. There may be placed an easily manageable size of data in storage 13.

Use of the present system may entail setting criteria and providing rules 16 including parameters to filter 15 for determining a way for reacting to events. The events may include system conditions, alarms, or suspect data which have a basis for a trend to be initiated and, subsequently, for that information or data to be archived in storage 13 for later retrieval and extensive trend analysis. Optimally, the user may be able to setup parameters which, overall, would allow pre-analysis to determine how and when to trigger trend data collection and to notify the user. This feature may also be accomplished with default settings so that the user would not have to set up any parameters for trend initiation. Once a condition is detected, the system may move the data to the configuration file 11 which can move the data to the log engine 12 for logging in the storage module. Filter 15 may trigger a trend event, and report to the user about the event, collect data, store the data, and then terminate the event data collection. The user may then determine whether there is a reason or desire to view and utilize the data, or to initiate at mechanism 14 the trend analysis of the logged data in storage module 13. The amount of data in storage module 13 is of a reasonable, easily manageable and inexpensive size.

The present approach may optimize the use of system monitoring and health resources, and optimize data set sizes making the system easier to use and to diagnose problems, free up the user from setting up data collection schemes, and save data storage space, which are important in embedded control systems, systems of small businesses and larger systems where data throughput is of concern.

The incoming or available data may be pre-filtered by filter 15 so as to decide whether it should be logged in. Filter 15 may check the what, when and the speed of the information to be reviewed. Information extraction may involve gathering as much data as possible from virtually all sources of concern, e.g., zones, stores, or other places. Then one may decide what to do with all of the data. The data may be combed through. Normal data is not necessarily sought, needed or kept. Interesting data may be selected out by filter 15 for logging and review. Virtually all data may be monitored while passing by. Just significant events may be logged in.

An example of data may include space temperature. Each minute may be monitored; however, just changes in degrees may be logged, for instance, a sensor indicating 20 degrees changing to 22 degrees may involve two data points.

There may be a logging scenario which incorporates pre-analyzed data as provided by filter 15 to configuration file 11 and to engine 12 for logging. An objective may be to reduce the number of examples or data points taken. There may be a variation within a norm that limits the number of data points taken over a certain period of time from a particular source. Certain circumstances may indicate capturing data outside the norm. The circumstances may result in criteria which include a number of data points taken and a period of time over which the points are taken. These factors may be part of the logging scenario.

In ordinary data accession and storage, a result may include reams of stored data. There may be rules for screening, analysis and post-analysis. Generally, just data of value may be logged. There may further be various kinds of rules 16 for determining the value of data. Included may be rules for anomalies, determinations of whether the data is good or not, decisions as what to do with the data, indications of data relevant to energy consumption and maintenance, and so on. The rules 16 may be provided to pre-analytic filter 15 for application to incoming data.

One approach may be to fill up storage with data 17. The data may be logged as files in storage 13. The files may indicate a point names (for data points), a frequency of data collection events, and a maximum size of each data collection event. There may be tens of thousands of data points. There may be a start time and a rolling window of data. The window may have a fixed size.

A factor may include a change of value (COV) in screening data. Frequency of collection may be determined by an amount of change of value. Logging and storage of the data may occur when the data has changed value. COV may be just one factor among others used in determination of logging and storage of data.

Virtually all data points may be taken in by filter 15 to be evaluated. Interesting points may be selected. Points that are selected should be logged, and also logged sufficiently fast enough to be useful. There may be a need to know or determine the duration that it takes for the points to be logged. A sufficient number of points for a given duration may be needed to obtain good resolution among the points required for detecting fast occurring nuances. Bandwidth of the system may be a factor.

The number of data points being captured may be subject to reduction. Reduction may be to just an amount of data which is deemed significant. A factor in the reduction of data amount and logged data points may include cost.

A number of parameters per zone of an HVAC or a component of other system may be considered. There may be a single parameter or a combination of multiple parameters. Noting a change of value may be one way or reason to take and log data. If there is no change of value, then the non-change of value may be flagged as an issue of the data. For example, if there is no change, the static level of data may indicate inaction, no new data, or malfunction of the equipment being monitored.

Various methodologies may be implemented by filter 15 when selecting out data for logging. In an analogous sense, various roles of people may subject them to various rules. Likewise, various purposes for data may subject them to various rules 16 for selection. In pre-filtering of data by filter 15, the rules 16 of the methodologies may determine whether the data should be taken and logged.

There may be trigger points which are a part of post-processing. Intelligent data logging decisions may include a reduction of data by just referring to a log description to determine when data needs to be logged. The data will not necessarily be logged unless it is to be logged for one good reason or another. Logging parameters may be designed and provided to filter 15 for a situation which is to be solved. A solution, based on input from filter 15 may be provided to configuration file 11. Log information and data may be provided to engine 12. In turn, engine 12 may log and store the selected data in storage module 13.

There may be local inputs and outputs and/or inputs and outputs of a network. Data points are not necessarily parameters. Space temperature may be a data point minus a set-point value of some degrees. The set-point may be a parameter. For example, a heating-occupied set-point or parameter may be 78 degrees F.

Flagging data for logging may be in response to data not changing. The flagging may be situation dependent. Added parameters may provide a better situation for a data selection process. One question may be whether the data is significant enough for storage. If not, then the data may be discarded. There may be situations where no data need be taken and stored. A sample filter may be based just on COV. However, the COV approach, if not carefully designed, may lead to large amounts of data taken and consequently be very expensive. Filter 15 may provide filtering with a much more extensive basis and reduce the amount of necessary data to be stored.

A point may be regarded as a piece of data. Parameters may be associated with a decision that the engine needs to make. Parameters may be specific rules and the rules may be applied to the information gathered. Points, data and data points may be regarded as being the same. “Information” may be a broader term than “points” and “data”. Terms described in the present description may not necessarily reflect conventional meanings.

In the present specification, some of the matter may be of a hypothetical or prophetic nature although stated in another manner or tense.

Although the present system has been described with respect to at least one illustrative example, many variations and modifications will become apparent to those skilled in the art upon reading the specification. It is therefore the intention that the appended claims be interpreted as broadly as possible in view of the prior art to include all such variations and modifications.

What is claimed is:

1. A system for data selection, comprising:
a pre-analysis data filter connected to sensors of equipment for building control;
a configuration file connected to the pre-analysis data filter;
a log engine connected to the configuration file; and
a storage module connected to the log engine.

2. The system of claim 1, wherein:
the pre-analysis filter is for selecting out significant data from data received from the sensors; and
the pre-analysis filter comprises a set of rules for selecting out the significant data.

3. The system of claim 2, wherein the significant data are provided to the configuration file.

4. The system of claim 3, wherein the significant data go from the configuration file to the log engine.

5. The system of claim 4, wherein the log engine logs the significant data in the storage module.

6. The system of claim 5, wherein the significant data is trend data.

7. The system of claim 6, wherein the amount of trend data is a fraction of the amount of data received from the sensors.

8. The system of claim 5, wherein the significant data is selected in accordance with a set of rules.

9. The system of claim 8, wherein the set of rules comprises:
parameters for limiting an amount of significant data which is to be selected over a particular duration of time;
parameters for determining how and when to trigger significant data collection.

10. The system of claim 9, wherein the set of rules further comprises:
values of the parameters; and
wherein:
the values are set by a user; and
the parameters have default settings for the values of the parameters if the values are not set by the user.

11. The system of claim 8, wherein the set of rules comprises:
criteria for an event to initiate a significant data selection; and
wherein:
an event is an equipment condition, alarm or suspect data; and
upon detecting the event, there is a creating, starting and stopping trends on the fly which consist of triggering of a trend, reporting of the trend to a user, collection of significant data of the trend, storing the significant data and then a termination of the significant data selection.

12. The system of claim 8, wherein the set of rules comprises:
a model of the equipment; and
interrelated environmental factors affecting the equipment.

13. The system of claim 12, wherein the set of rules further comprises parameters for energy management of the equipment.

14. The system of claim 12, wherein the set of rules further comprises parameters for health resources, diagnostics and maintenance of the equipment

15. The system of claim 8, wherein:
the pre-analysis data filter monitors virtually all incoming data; and
incoming data, not selected as significant data, are discarded.

16. A method for data selection, comprising:
taking data from sensors of equipment for building control;
selecting out significant data from data received from the sensors according to a set of rules;
configuring the significant data; and
storing the significant data.

17. The method of claim 16, the rules comprise:
parameters for limiting an amount of significant data which is to be selected over a particular duration of time; and
parameters for determining how and when to trigger significant data collection.

18. The method of claim 17, wherein the significant data indicate a trend.

19. A system for obtaining trend data, comprising:
a pre-analysis data filter connected to sensors of equipment for building control;
a configuration file connected to the pre-analysis data filter;
a log engine connected to the configuration file; and
a storage module connected to the log engine;
wherein:
the pre-analysis filter monitors data from the sensors;
the pre-analysis filter selects out trend indicating data from the data from the sensors according to an event; and
an event is an equipment condition, alarm or suspect data.

20. The system of claim 19, wherein detecting events results in creating, starting and stopping trends on the fly.
